(19) United States
(12) Patent Application Publication
(10) Pub. No.: US 2013/0202831 A1
(43) Pub. Date: Aug. 8, 2013

(54) PEBA-BASED COMPOSITION AND USE THEREOF FOR THE MANUFACTURE OF A TRANSPARENT ARTICLE HAVING HIGH-VELOCITY IMPACT RESISTANCE

(71) Applicants: Sophie Chhun, Limeil-Brevannes (FR); Benjamin Saillard, Bernay (FR); Frederic Malet, Rouen (FR); Jerome Allanic, Billiers (FR)

(72) Inventors: Sophie Chhun, Limeil-Brevannes (FR); Benjamin Saillard, Bernay (FR); Frederic Malet, Rouen (FR); Jerome Allanic, Billiers (FR)

(73) Assignee: ARKEMA FRANCE, COLOMBES (FR)

(21) Appl. No.: 13/823,752

(22) PCT Filed: Sep. 27, 2011
(86) PCT No.: PCT/FR2011/052247

§ 371 Date: Apr. 16, 2013

(30) Foreign Application Priority Data
Sep. 28, 2010 (FR) 1003844

(51) Int. Cl. C08L 77/06; B29C 45/00; C08G 81/00

(52) U.S. Cl. CPC C08L 77/06; C08G 81/00; B29C 45/0001
USPC 428/36.9; 525/432; 525/420; 524/538; 524/606; 524/607; 264/328.1; 428/220; 428/35.7

(57) ABSTRACT

A copolymer containing polyether (PE) block(s) and polyamide (PE) block(s) issued for the manufacture of a transparent article having high-velocity impact resistance, and impact strength. In said copolymer:
PA blocks comprise more than 50 mol % of an equimolar combination of at least one cycloaliphatic diamine and of at least one aliphatic dicarboxylic acid having from 12 to 36 carbon atoms, represent 20 to 90% by weight, out of the total weight of the copolymer, have a number-average molecular weight of 1000 to 10 000 g/mol, and the PE blocks represent 10 to 80% by weight, out of the total weight of the copolymer, and have a number-average molecular weight of 200-1000 g/mol.

The invention relates to the use of novel thermoplastic polymer compositions used for the manufacture of articles that combine excellent transparency and high-velocity impact resistance properties. One subject of the invention is more particularly the manufacture of transparent protective equipment, such as safety goggles, ballistic glazing, shielded windows, helmets, visors, etc.

Among transparent polymers, it is polycarbonate (PC) which is used in situations where protection is the main criterion. Polycarbonate is characterized by its impact resistance, but its transparency is lower compared to glass. The first bulletproof windows and glazing were made of polycarbonate.

Impact-strengthened polyamide (PA) also exists, for example the impact-strengthened polyamide BACM,12, i.e. strengthened by an impact modifier or impact strengthener, such as a modified polyolefin. The materials formed from these PAs have the advantage of being light, but their transparency, their high-velocity impact resistance and their impact strength are lower than that of PC.

Moreover, the high glass transition temperature (T_{g}), above 150° C., of PC and of these impact-strengthened transparent PAs may render the conversion (in particular the injection molding) of these materials more difficult, sometimes with material shrinkage problems.

Today, an alternative to PC is sought among materials that are more transparent, have better high-velocity impact resistance and impact strength, are lighter, are more flexible, have better chemical resistance than PC and that are easy to process with the existing processes or devices for shaping polymers.

More precisely, the objective of the present invention is to provide novel polymer compositions for the manufacture of an article made of a material:
having a “transparency” such that the transmittance of the material is at least equal to 90% at 560 nm through a sheet having a thickness of 2 mm (according to the ISO 13468 standard),
that is “resistant to a high-velocity impact”, i.e. a velocity impact at least equal to 76.2 m/s (250 ft/s) according to the EN 166 standard, preferably at least equal to 198 m/s (i.e. 650 feet/second or 650 ft/s),
having a Charpy notched “impact strength” of at least 90 kJ/m² according to the ISO 179 leU standard,
that is “lightweight” having a density of less than 1.05 g/cm³ measured according to the ISO 1183 D standard,
having a “chemical resistance” or “solvent resistance” such that the material is capable of deforming by at least 3% without breaking, in flexion, in immersion in a solvent, such as isopropanol (stress cracking according to the ISO 22088-3 standard),
that is “flexible”: having an elastic modulus of less than 1000 MPa, preferably of less than 800 MPa, measured according to the ISO 527-2:93-1BA standard.

Another objective of the present invention is to provide a process for manufacturing such articles which is simple, easy to implement, rapid (which has the fewest steps possible), and which avoids the problems of shrinkage, in particular after injection molding.

A means of obtaining an article combining all these properties has now been found by the use of a particular range of copolymers containing polyamide blocks and polyether blocks according to the invention, alone or as a mixture with at least one transparent amorphous polyamide.

The “copolymers containing polyether blocks and polyamide blocks” are abbreviated hereinbelow by “PEBA”.

The copolymers suitable for use according to the invention correspond to a particular range of PEBA selected from the family of amorphous PEBAs (delta Hm(2))=0 J/g) or of PEBAs which have a crystallinity such that the enthalpy of fusion (delta Hm(2)) during the second heating of an ISO DSC is at most equal to 30 J/g, the mass being relative to the amount of amide units contained or of polyamide contained, this fusion corresponding to that of the amide units. This family of amorphous or not very semicrystalline PEBAs, and the process for obtaining them, are described in patent application WO 2008/006987, from page 5, line 19 to page 9, line 35.

### DETAILED DESCRIPTION OF THE INVENTION

In the present description, it is specified that:
the limits are excluded when “between” two limits is written, and
the limits are included when “the range from X to Z” or “represent 20 to 90%” are written.

One subject of the present invention is therefore the use of a copolymer containing polyether blocks and polyamide blocks for the manufacture of an article:
that is transparent having a transmittance at least equal to 90% at 560 nm through a sheet having a thickness of 2 mm (according to the ISO 13468 standard);
that is resistant to a high-velocity impact of at least 76.2 m/s (250 ft/s) according to the EN 166 standard; and
that has a Charpy notched impact strength of at least 90 kJ/m² according to the ISO 179 leU standard;
   and preferably also:
that has a chemical resistance such that it is capable of deforming, in flexion, by immersion in a solvent according to the ISO 22088-3 standard by at least 3% without breaking;
that is light, having a density of less than 1.05 g/cm³ measured according to the ISO 1183 D standard;
that is flexible and has an elastic modulus of less than 1000 MPa, preferably of less than 800 MPa, measured according to the ISO 527-2:93-1BA standard,
   in which said copolymer has the following characteristics.
   Within the meaning of the invention, the expression “copolymer containing PE block(s) and PA block(s)” covers, in particular, PEBAs comprising one or more PE blocks and one or more PA blocks.

According to the present invention, said PA blocks comprise more than 50 mol % of an equimolar combination of at least one cycloaliphatic diamine and of at least one aliphatic, preferably predominantly (more than 50 mol %) linear, dicarboxylic acid having from 12 to 36, preferably from 12 to 18, carbon atoms.

This particular composition of PA blocks (content and chemistry) of the PEBA helps in particular to obtain a transparency (transmittance at least equal to 90%) in accordance with the requirements of the invention.

According to one preferred embodiment, the PA blocks of the copolymer used in the invention comprise more than 70 mol %, preferably more than 80 mol %, preferably more than 90 mol %, preferably 100 mol % of an equimolar combination of at least one cycloaliphatic diamine and of at least one aliphatic, preferably linear, dicarboxylic acid having from 12 to 18 carbon atoms.

Said at least one cycloaliphatic diamine is advantageously chosen from: bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane (BMACM or MACM or B), p-bis(aminocyclohexyl)methane (PACM), isopropylidenedi(cyclohexylamine) (PACP), isophoronediamine (IPD), 2,6-bis(aminomethyl)norbornane (BAMN), and mixtures thereof.

Advantageously, a single cycloaliphatic diamine, in particular bis(3-methyl-4-aminocyclohexyl)methane, is used as diamine for obtaining the PA blocks.

At least one non-cycloaliphatic diamine may be incorporated into the composition of the monomers of the PA blocks, in a proportion of at most 30 mol % relative to the diamines of said composition. As non-cycloaliphatic diamines, mention may be made of linear aliphatic diamines, such as 1,4-tetramethylene-diamine, 1,6-hexamethylenediamine, 1,9-nonadiamine and 1,10-decamethylene-diamine.

C12 to C18 aliphatic dicarboxylic acid is preferably chosen from 1,12-dodecanedicarboxylic acid, 1,14-tetradecanedicarboxylic acid and 1,18-octa-decanedicarboxylic acid.

The dicarboxylic acid may optionally be at least partially branched with at least one C1 to C3 alkyl group (having 1 to 3 carbon atoms).

At least one non-aliphatic dicarboxylic acid may be incorporated into the composition of the monomers of the PA blocks in a proportion of at most 15 mol % relative to the dicarboxylic acids of the PAs. Preferably, the non-aliphatic dicarboxylic acid is chosen from aromatic diacids, in particular isophthalic acid (I), terephthalic acid (T) and mixtures thereof.

The term “monomer” in the present description of the polyamides should be taken in the sense of “repeating unit”. Indeed, the case where a repeating unit of the PA consists of the combination of a diacid with a diamine is distinctive. It is considered that it is the combination of a diamine and of a diacid, that is to say the diamine.diacid pair (in an equimolar amount) which corresponds to the monomer. This is explained by the fact that individually, the diacid or the diamine is only a structural unit, which is not sufficient, by itself, to polymerize.

Said PA blocks may optionally comprise less than 50 mol % of at least one polyamide comonomer, that is to say a monomer having a composition different from said predominant equimolar combination defined previously.
Thus, the comonomer comprises, for example, a C10 (10 carbon atoms) linear dicarboxylic acid.
Preferably, said PA block comprises less than 30 mol %, preferably less than 20 mol %, preferably less than 10 mol % of polyamide comonomer(s), it being possible for said at least one comonomer to be chosen from lactams, α,ω-aminocarboxylic acids, diamine.diacid combinations different from that defined previously, and mixtures thereof.

The lactam is, for example, chosen from caprolactam, oenantholactam and lauryllactam. The α,ω-aminocarboxylic acid is, for example, chosen from aminocaproic acid, 7-aminoheptanoic acid, 11-aminoundecanoic acid or 12-amino-dodecanoic acid.

Preferably, the PA blocks are mainly (more than 80 mol %) formed from at least one monomer chosen from B,12, B,14, B,16, B,18, random and/or block copolymers (copolyamides) thereof, and mixtures thereof.

Said PA blocks represent 20 to 90% by weight, preferably from 40 to 80% by weight, preferably from 60 to 80% by weight, out of the total weight of the copolymer used according to the invention.

The number-average molecular weight of the PA blocks is within the range from 1000 to 10 000 g/mol, preferably from 1500 to 7000 g/mol. The low weights give a copolymer having a low glass transition temperature T_{g} of from 75 to 80° C., whereas the highest molecular weights set the T_{g} of the copolymer in the vicinity of 150° C.

The T_{g} of the block copolymers used according to the invention is therefore advantageously within the range from 75° C. to 150° C., preferably within the range from 90° C. to 150° C. Advantageously, the processing, via injection molding, of the copolymers and compositions according to the invention is possible at a lower temperature than that required for the injection molding of PC, in particular at a temperature below 150° C., or even below 100° C. The injection molding of PEBA or of the composition comprising it according to the invention is easy and results in very little shrinkage after injection molding, which makes it possible to obtain parts of high dimensional precision.
Moreover, the conventional coating processes of the “hard-coating” type that tend to be carried out today at temperatures in the vicinity of the upper T_{g} limit (150° C.) can also be envisaged on the flexible and transparent articles obtained according to the invention.

Said PE blocks represent 10 to 80% by weight, preferably from 20 to 60% by weight, preferably from 20 to 40% by weight, out of the total weight of the copolymer. Indeed, the content of PE blocks is at least 10% in order to guarantee an impact strength and a high-velocity impact resistance that are sufficient for the uses of the invention.

The number-average molecular weight of the PE blocks is between 200 and 1000 g/mol (limits excluded), preferably within the range from 400 to 800 g/mol (limits included), preferably from 500 to 700 g/mol.

It emerges that the molecular weight of the PE blocks must be less than 1000 g/mol in order to guarantee a transparency such that the transmittance of an article according to the invention is at least equal to 90%.

The PE (polyether) blocks are, for example, derived from at least one polyalkylene ether polyol, in particular a polyalkylene ether diol, preferably chosen from polyethylene glycol (PEG), polypropylene glycol (PPG), polytrimethylene glycol (PO3G), polytetramethylene glycol (PTMG) and mixtures thereof or copolymers thereof. The PE blocks may comprise polyoxyalkylene sequences having NH₂ chain ends, it being possible for such sequences to be obtained by cyanoacetylation of aliphatic α,ω-dihydroxylated polyoxyalkylene sequences known as polyether diols. More particularly, use could be made of Jeffamines (for example Jeffamine® D400, D2000, ED 2003, XTJ 542, commercial products from Huntsman).

Said at least one PE block preferably comprises at least one polyether chosen from polyalkylene ether polyols, such as PEG, PPG, PO3G, PTMG, polyethers containing polyoxyalkylene sequences with NH₂ chain ends, random and/or block copolymers (copolyethers) thereof, and mixtures thereof.

Another subject of the present invention is the use of a thermoplastic polymer composition containing:
from 30 to 99.99%, preferably from 40 to 99.99% by weight of copolymer according to the invention as defined previously,
from 0.01 to 70%, preferably from 0.01 to 60% by weight of at least one amorphous, transparent and at least partially cycloaliphatic, preferably non-aromatic, polyamide,
from 0 to 20% of additives,
   out of the total weight of the composition,
   for the manufacture of an article having transparency, high-velocity impact resistance, impact strength, and even chemical resistance, density, and flexibility that are in accordance with those defined previously according to the invention.

The expression “transparent amorphous polyamides” is understood to mean transparent polyamides that are amorphous (delta Hm(2)=0 J/g) or that are not very semicrystalline (enthalpy of fusion during the second DSC heating of less than 30 J/g), which are rigid (ISO flexural modulus>1300 MPa), which do not deform at high temperature, at 60° C., since the glass transition temperature T_{g} is above 75° C. However, they have quite a low impact strength, having a much lower ISO Charpy notched impact in comparison with impact-modified polyamides, and their chemical resistance is not excellent in particular due to their amorphous nature. Transparent semicrystalline (or microcrystalline) polyamides also exist—but these are less common materials—typically with enthalpies of fusion during the second DSC heating of between 2 and 30 J/g, these materials also being quite rigid, having an ISO flexural modulus>1000 MPa.

Transparent amorphous polyamides (homopolyamides or copolyamides) that can be used in the compositions according to the invention are, in particular, described in patent documents EP 1 595 907 and WO 09/153,534. By way of example of transparent amorphous polyamides, mention may be made of PA-B,12, PA-11/B,14, and PA-11/B,10.

Preferably, the transparent amorphous PAs used according to the invention are non-aromatic, so as not to increase the T_{g} of the composition, so as to facilitate the homogenization of the composition, so as not to increase the conversion or forming temperature of the composition, and so as not to risk degrading the PEBA(s) of the composition.

The chemical composition of said amorphous polyamide is preferably chosen from the compositions already described for the polyamide blocks of the PEBAs above, which ensures the compatibility of the PA with the PEBA.

The addition, starting from 30%, preferably from 40% by weight, of a block copolymer according to the invention to an amorphous transparent polyamide according to the composition of the invention makes it possible to give said transparent polyamide high-velocity impact resistance and impact strength while retaining its transparency properties.

Said copolymer and the amorphous PA which are used in the composition of the invention preferably have substantially the same refractive index measured according to the ISO 489 standard. It is also possible to play with the nature of the raw materials used for synthesizing the PEBA and the PA. Generally, the addition of an aromatic compound (for example an aromatic diacid) increases the refractive index of a product. For the PEBAs according to the invention, the refractive index decreases if, for example, the PTMG content is increased relative to the pure PA of the same composition as the PA block of the PEBA. In the series of PAs of BMACM,Y type, Y being an aliphatic diacid, the longer Y is, the more the refractive index drops. For an aliphatic linear PA, the more the number of CH₂ increases in the unit, the more the refractive index drops.

If there is an additive in the composition, it is present from 0.01 to 20%, preferably from 0.01 to 10%, preferably from 0.01 to 5%, by weight out of the total weight of the composition. The additive is chosen, in particular, from coloring agents, in particular pigments, dyes, effect pigments, such as diffractive pigments, interference pigments, such as pearlescent agents, reflective pigments and mixtures thereof; UV stabilizers, anti-aging agents, antioxidants, fluidizing agents, anti-abrasion agents, mold-release agents, stabilizers, plasticizers, impact modifiers, surfactants, brighteners, fillers, fibers, waxes, and mixtures thereof, and/or any other additive well known in the field of polymers.

Among the fillers, mention may especially be made of silica, carbon black, carbon nanotubes, expanded graphite, titanium oxide or else glass beads.

The use according to the invention makes it possible to obtain an article that is more transparent, is more resistant to high-velocity impact, has higher impact strength, and is preferably also more resistant to chemical solvents, lighter, more flexible, and easier to process than an article of the same shape made of PC, as demonstrated in table 1 of the examples below.

Another subject of the present invention is a polyamide-based transparent thermoplastic polymer composition, said composition comprising:
from 30 to 100%, preferably from 40 to 100%, by weight of copolymer according to the invention as defined previously,
from 0 to 70%, preferably from 0 to 60% by weight of at least one amorphous, transparent and at least partially cycloaliphatic polyamide, preferably which is non-aromatic, and more preferably which has the same refractive index measured according to the ISO 489 standard as said copolymer, and as described previously,
from 0 to 20% of additive,

out of the total weight of the composition.

If there is an additive, it is present from 0.01 to 20%, preferably from 0.01 to 10%, preferably from 0.01 to 5%, by weight out of the total weight of the composition. The additive is chosen, in particular, from those already described previously.

According to one embodiment, the composition of the invention is manufactured by compounding or else by dry blending its various components. Dry blending is preferred since it comprises fewer steps and generally results in fewer risks of pollution (black spots, gels) of the composition than by compounding.

Said composition may be used according to the invention for manufacturing granules or powders, which may in turn be used in conventional processes for forming polymers for the manufacture of filaments, pipes, films, sheets and/or articles that are molded, transparent and resistant to high-velocity impact. One subject of the present invention is in particular a process for manufacturing a transparent and high-velocity impact-resistant article, said process comprising:
a step of supplying a copolymer in accordance with that defined previously;
an optional step of mixing said copolymer with at least one amorphous transparent PA and/or at least one additive, so as to manufacture a composition as defined previously;
a step of processing, in particular in a mold or a die, the copolymer or the composition at a temperature T0 within the range from 80 to 180° C., preferably from 90 to 150° C.;
then a step of recovering the transparent article.

The term “processing” is understood here to mean any process for forming polymers, such as molding, injection molding, extrusion, coextrusion, hot-pressing, multi-injection molding, rotomolding, sintering, laser sintering, etc. starting from the composition or copolymer according to the invention.

For the process of manufacturing articles, in particular molded, injection-molded or extruded articles according to the invention, granules are favored. Less commonly, use is made of powders having a median diameter by volume (measured according to the ISO 9276 standard—parts 1 to 6) within the range from 400 to 600 μm. According to one particular forming method of the process of the invention, in particular by sintering such as laser sintering or else by rotomolding, the compositions according to the invention are preferably in the form of powder, the particles of which have a median diameter by volume of less than 400 μm, preferably of less than 200 μm. Among the methods of manufacturing powder, mention may be made of cryogenic milling and micro granulation.

Another possible embodiment of the process of the present invention may also comprise a preliminary step of compounding PEBA with dyes, and/or any other additive, before said step of manufacturing granules or powder.

Another subject of the invention is the use of a PEBA and/or of a thermoplastic composition as defined above for the manufacture of transparent protective equipment, industrial safety equipment, such as safety goggles, safety frames and/or safety glass, ballistic glazing, an impact-resistant transparent sheet, a helmet, a visor, a shield, a protective suit; sports equipment; a watchglass; space equipment, in particular satellite or space shuttle equipment; aeronautical or motor vehicle equipment, such as a windshield, glazing, a porthole, a cockpit, an aircraft canopy, a window, bulletproof glazing, for example for a car or a structure, spotlight or headlight glazing; display glazing, in particular advertising, electronic or computer glazing; a screen component; glazing for a thermal, solar or photovoltaic panel; an article for the construction, furnishing, electrical appliance or decorative industry; for the games or toys industry; for the fashion industry, such as shoe heels or jewels; for the furniture industry, such as a table, seat or armchair component; a presentation, packaging, housing, box, container or flask article or component, an article for perfumery, for the cosmetics or pharmaceutical industry; luggage; or a component for protection during transport.

The present invention also relates to any transparent article having high-velocity impact resistance, having a composition in accordance with that defined previously. Preferably, the article according to the invention has these advantageous properties even if it has a small thickness within the range extending from 0.1 to 10 mm, preferably from 0.1 to 3 mm, preferably from 0.5 to 2 mm.

### EXAMPLES

The examples below illustrate the present invention without limiting the scale thereof. In the examples, unless otherwise indicated, all the percentages and parts are expressed by weight.

Several types of transparent PEBAs are tested alone or as a mixture with a transparent amorphous polyamide and are compared with polycarbonate (PC) and with polyamide B,12 impact-strengthened by a modified polyolefin.
Transparent amorphous polyamides used:
   PA-B,12 represents the polyamide of a monomer formed by the BMACM diamine and dodecanedioic acid pair (Grilamid TR 90, sold by EMS).
   PA-11/B,14 is a copolyamide comprising 94 mol % of a B,14 monomer (in which “14” represents tetradecanedioic acid) and 6 mol % of a comonomer formed by 11-aminoundecanoic acid.
   PA-11/B,10 comprises 72 mol % of a B,10 monomer (in which “10” represents sebacic acid containing 10 carbon atoms) and 28 mol % of a comonomer formed by 11-aminoundecanoic acid.
   These polyamides are prepared according to the process described in patent document WO 2009/153534, from page 20, line 12 to page 21, line 9.
PEBAs used, containing PA blocks (respectively homopolyamide B,12, and copolyamide B,10/B,14 or B,12/B,14 or B,14/B,18) and containing PTMG blocks:
   B,12—PTMG is a PEBA containing PA blocks containing 100 mol % of B,12 monomer and containing PTMG blocks.
   B,10/B,14—PTMG is a PEBA containing PA blocks comprising 50 mol % of B,14 monomer and 50 mol % of B,10 monomer, and containing PTMG blocks.
   B,12/B,14—PTMG is a PEBA containing PA blocks comprising 50 mol % of B,12 monomer and 50 mol % of B,14 monomer, and containing PTMG blocks.
   B,14/B,18—PTMG is a PEBA containing PA blocks comprising 50 mol % of B,14 monomer and 50 mol % of B,18 monomer, and containing PTMG blocks.
   Although, in the examples below, the PTMG blocks are generally used as PE blocks, the invention is obviously not limited to this embodiment and it would not depart from the scope of the invention to replace the PTMG blocks with any other PE block such as described previously.

The size of the PA and PE blocks (number-average molecular weight) of the PEBAs is respectively indicated at the top of table 1 from FIG. 1 under the PEBA used.

The transparency, yellowness index and haze properties (table 3) are measured on a sheet having a thickness of 2 mm.
The high-velocity impact resistance, impact strength and flexibility properties are tested on standardized test specimens in accordance with the standards used and indicated in table 1, the chemical resistance properties are measured on IFC (Institut français du caoutchouc [French Institute of Rubber]) test specimens and the lightness (density) properties are measured on granules. All these properties are measured respectively according to the standards indicated in table 1 from FIG. 1 and in tables 2 and 3.
These sheets and test specimens are obtained by injection molding starting from granules of PEBA, optionally dry blended first with granules of PA, of compositions specified above, and as is indicated in table 1.
Table 1 shows that only examples 1 to 4 (Ex1 to Ex4) according to the invention combine high transparency and high-velocity impact resistance, unlike the comparative examples 1 to 6 (Cp1 to Cp6).
The impact strength, chemical resistance, lightness and flexibility of the examples according to the invention are also better than those of polycarbonate (PC).
The chemical resistance measured by deformation under stress (ISO 22088-3 standard, 22 h, 23° C.) was measured in particular with respect to ethanol and isopropanol. Tables 1 and 2 show chemical resistances in accordance with the test specimens of the examples according to the invention, in particular for Ex2 made of PEBA of composition B,12-PTMG (the PA and PE blocks having respective number-average molecular weights of 2000 and 650 g/mol).

TABLE 2

| | | Cp3 | Ex 2 |
|---|---|---|---|
| Formulation | | PA-11/B,14 | B,12 - PTMG |
| test specimen thickness | | 2 | 2 |
| (mm) | | | |
| strain imposed (%) | | 3.0% | 3.0% |
| Ethanol | 22 h | Does not break | Does not break |
| | immersion | | |
| Isopropanol | 22 h | breaks | Does not break |
| | immersion | | |

The use of PEBA according to the invention also has other advantages as shown in table 3: a less yellow tint (lower yellowness index Yi), a lower haze, and a better transmittance (at 560 nm through a sheet having a thickness of 2 mm, measured using a Konica-Minolta 3610d spectrophotometer, according to the ISO 13468 standard), in comparison with the respective values found for impact-strengthened PA-B,12:

TABLE 3

| | | Haze | Yi | Tr % |
|---|---|---|---|---|
| | | (ASTM | (ASTM | (560 nm, 2 mm, |
| | Product: | D1003-97) | E313-96) | ISO 13468) |
| Ex 2 | B,12-PTMG | 2.2 | 2.4 | 91.3 |
| Cp2 | Impact-strengthened | 17.7 | 10.8 | 82.6 |
| | B,12 | | | |

TABLE 1

| | | | | | | | Cp5 | Ex1 |
|---|---|---|---|---|---|---|---|---|
| | | | | | | | 80% | 60% |
| | | | | Cp2 | | | PA-11/B,14 + | PA-11/B,14 + |
| | | Required/ | | Impact- | Cp3 | Cp4 | 20% | 40% |
| | | OK | Cp1 | strengthened | PA- | PA- | B,12-PTMG | B,12-PTMG |
| Properties/standard | Unit | if | PC | PA-B,12 | 11/B,14 | 11/B,10 | (2000-650) | (2000-650) |
| Flexibility - | MPa | <1000 MPa | 2400 | 1200 | 1300 | 1500 | 1200 | 950 |
| Elastic modulus/ | | | | | | | | |
| ISO 178 | | | | | | | | |
| Transparency - | % | min 90% | 88 | 82.6 | 91.5 | 91.5 | 90.6 | 90.1 |
| Transmittance/ | | | | | | | | |
| ISO 13468 | | | | | | | | |
| (560 nm, 2 mm) | | | | | | | | |
| High-velocity impact | | does not | OK | breaks | breaks | breaks | breaks | OK |
| resistance | | break: OK | | | | | | |
| (76.2 m/s, 2 mm)/ | | | | | | | | |
| EN 166 | | | | | | | | |
| Very-high-velocity | | does not | breaks | breaks | breaks | breaks | breaks | — |
| impact resistance | | break: OK | | | | | | |
| (198 m/sec, 2 mm)/ | | | | | | | | |
| EN 166 | | | | | | | | |
| Charpy notched | kJ/m² | min 90 kJ/m² | 95 | 53 | 12 | 11 | <90 | OK |
| impact strength at | | | | | | | | |
| 23° C./ISO 179, 1eU | | | | | | | | |
| Chemical resistance - | % | min 3% | <3% | — | <3% | <3% | — | — |
| flexural | | | | | | | | |
| deformation/ISO | | | | | | | | |
| 22088-3, 22 h, 23° C., | | | | | | | | |
| pure solvent: | | | | | | | | |
| isopropanol | | | | | | | | |
| Lightness - Density/ | g/cm³ | <1.05 g/cm³ | 1.2 | 0.99 | 0.99 | 1.01 | 1.00 | 1.01 |
| ISO 1183 D | | | | | | | | |
| Process - T_{g}/ | ° C. | 75° C.-150° C. | 150 | 150 | 145 | 135 | 130 | 120 |
| ISO 11357 | | | | | | | | |

| | | | Ex2 | Ex3 | Ex4 | Cp6 |
|---|---|---|---|---|---|---|
| | | Required/ | B,12- | B,12/B,14- | B,14/B,18- | B,10/B,14- |
| | | OK | PTMG | PTMG | PTMG | PTMG |
| Properties/standard | Unit | if | (2000-650) | (2000-650) | (2000-1000) | (4000-1000) |
| Flexibility - | MPa | <1000 MPa | 740 | 710 | OK | OK |
| Elastic modulus/ | | | | | | |
| ISO 178 | | | | | | |
| Transparency - | % | min 90% | 91.3 | 91 | 90.8 | 88 |
| Transmittance/ | | | | | | |
| ISO 13468 | | | | | | |
| (560 nm, 2 mm) | | | | | | |
| High-velocity impact | | does not | OK | OK | OK | OK |
| resistance | | break: OK | | | | |
| (76.2 m/s, 2 mm)/ | | | | | | |
| EN 166 | | | | | | |
| Very-high-velocity | | does not | OK | OK | OK | OK |
| impact resistance | | break: OK | | | | |
| (198 m/sec, 2 mm)/ | | | | | | |
| EN 166 | | | | | | |
| Charpy notched | kJ/m² | min 90 kJ/m² | 94 | 110 | OK | OK |
| impact strength at | | | | | | |
| 23° C./ISO 179, 1eU | | | | | | |
| Chemical resistance - | % | min 3% | ≧3% | ≧3% | ≧3% | ≧3% |
| flexural | | | | | | |
| deformation/ISO | | | | | | |
| 22088-3, 22 h, 23° C., | | | | | | |
| pure solvent: | | | | | | |
| isopropanol | | | | | | |
| Lightness - Density/ | g/cm³ | <1.05 g/cm³ | 1.01 | — | — | — |
| ISO 1183 D | | | | | | |
| Process - T_{g}/ | ° C. | 75° C.-150° C. | 90 | 91 | 85 | 119 |
| ISO 11357 | | | | | | |

1. A method for the manufacture of a transparent article having high-velocity impact resistance; and impact strength, comprising injection molding a composition comprising polyether block(s) and polyamide block(s):
said PA blocks comprising more than 50 mol % of an equimolar combination of at least one cycloaliphatic diamine and of at least one aliphatic dicarboxylic acid having from 12 to 36 carbon atoms,
said PA blocks representing 20 to 90% by weight, out of the total weight of the copolymer,
the number-average molecular weight of the PA blocks being within the range from 1000 to 10 000 g/mol,
said PE blocks representing 10 to 80% by weight, out of the total weight of the copolymer, and
the number-average molecular weight of the PE blocks being between 200 and 1000 g/mol.

2. The method according to claim 1, comprising employing:
from 30 to 99.99% by weight of the copolymer,
from 0.01 to 70% by weight of at least one amorphous, transparent and at least partially cycloaliphatic polyamide,
from 0 to 20% of additives, and
out of the total weight of the composition.

3. The method as claimed in claim 1, in which the article is more transparent and more resistant to a high-velocity impact than an object of the same shape made of polycarbonate.

4. The method as claimed in claim 3, in which the article also has higher impact strength, is more resistant to chemical solvents and is lighter, than an article of the same shape made of polycarbonate.

5. The method as claimed in claim 1, in which the PA blocks comprise more than 70 mol % of an equimolar combination of at least one cycloaliphatic diamine and of at least one aliphatic, optionally linear, dicarboxylic acid having from 12 to 18 carbon atoms.

6. The method as claimed in claim 1, in which said at least one cycloaliphatic diamine is: bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-amino-cyclohexyl)methane (BMACM or MACM), p-bis(aminocyclohexyl)methane (PACM), isopropylidenedi(cyclohexylamine) (PACP), isophoronediamine (IPD), 2,6-bis(aminomethyl)norbornane (BAMN), or mixtures thereof.

7. The method as claimed in claim 1, in which said PA block comprises less than 30 mol % of at least one polyamide comonomer different from said equimolar combination.

8. The method as claimed in claim 1, in which said at least one PE block comprises at least one polyether that is a polyalkylene ether polyol, a polyether containing polyoxyalkylene sequences with NH₂ chain ends, random and/or block copolymers thereof, or mixtures thereof.

9. The method as claimed in claim 1, in which the PA blocks are more than 80 mol % formed from at least one monomer that is B,12, B,14, B,16, B,18, random and/or block copolymers thereof, or mixtures thereof.

10. A polyamide-based transparent thermoplastic polymer composition, said composition comprising:
from 30 to 100% by weight of copolymer comprising polyether block(s) and polyamide block(s), in which
said PA blocks comprising more than 50 mol % of an equimolar combination of at least one cycloaliphatic diamine and of at least one aliphatic dicarboxylic acid having from 12 to 36 carbon atoms,
said PA blocks representing 20 to 90% by weight, out of the total weight of the copolymer,
the number-average molecular weight of the PA blocks being within the range from 1000 to 10 000 g/mol,
said PE blocks representing 10 to 80% by weight, out of the total weight of the copolymer, and
the number-average molecular weight of the PE blocks being between 200 and 1000 g/mol
from 0 to 70% by weight of at least one amorphous, transparent and at least partially cycloaliphatic polyamide,
from 0 to 20% of additive,
out of the total weight of the composition.

11. The composition as claimed in claim 10, in which the additive is: coloring agents, dyes, effect pigments, diffractive pigments, interference pigments, pearlescent agents, reflective pigments or mixtures thereof; UV stabilizers, anti-aging agents, antioxidants; fluidizing agents, anti-abrasion agents, mold-release agents, stabilizers; plasticizers, impact modifiers; surfactants; brighteners; fillers, fibers, waxes; or mixtures thereof.

12. The composition as defined in claim 10, in the form of granules or powders.

13. Filaments, pipes, films, sheets and/or articles that are molded, transparent and high-velocity impact resistant, produced from granules as defined in claim 12.

14. A process for manufacturing a transparent and high-velocity impact resistant article, said process comprising:
supplying a copolymer containing polyether blocks and polyamide blocks, in which
said PA blocks comprising more than 50 mol % of an equimolar combination of at least one cycloaliphatic diamine and of at least one aliphatic dicarboxylic acid having from 12 to 36 carbon atoms,
said PA blocks representing 20 to 90% by weight, out of the total weight of the copolymer,
the number-average molecular weight of the PA blocks being within the range from 1000 to 10 000 g/mol,
said PE blocks representing 10 to 80% by weight, out of the total weight of the copolymer, and
the number-average molecular weight of the PE blocks being between 200 and 1000 g/mol;
optionally mixing said copolymer with at least one amorphous transparent PA and/or at least one additive, so as to manufacture a composition;
processing said copolymer or said composition at a temperature T0 within the range from 90 to 180° C.;
recovering the article.

15. A process for the manufacture of an article that is transparent protective equipment, industrial safety equipment, such as safety goggles, safety frames and/or safety glass, ballistic glazing, an impact-resistant transparent sheet, a helmet, a visor, a shield, a protective suit; sports equipment; a watchglass; space equipment, satellite or space shuttle equipment;
aeronautical or motor vehicle equipment, a windshield, glazing, a porthole, a cockpit, an aircraft canopy, a window, bulletproof glazing, spotlight or headlight glazing; display glazing, advertising, electronic or computer glazing; a screen component; glazing for a thermal, solar or photovoltaic panel; an article for the construction, furnishing, electrical appliance or decorative industry; an article for the games or toys industry; an article for the fashion industry, shoe heels or jewels;
for the furniture industry, a table, seat or armchair component; a presentation, packaging, housing, box, container or flask article or component, an article for perfumery, cosmetics or pharmaceuticals; luggage; or a component for protection during transport, comprising producing said article by injection molding of a composition according to claim 10.

16. A transparent article having high-velocity impact resistance, the composition of which is in accordance with claim 10.

17. The article as claimed in claim 16, having a thickness within the range extending from 0.1 to 10 mm.

18. In an article that is transparent protective equipment, industrial safety equipment, such as safety goggles, safety frames and/or safety glass, ballistic glazing, an impact-resistant transparent sheet, a helmet, a visor, a shield, a protective suit; sports equipment; a watchglass; space equipment, satellite or space shuttle equipment; aeronautical or motor vehicle equipment, a windshield, glazing, a porthole, a cockpit, an aircraft canopy, a window, bulletproof glazing, spotlight or headlight glazing; display glazing, advertising, electronic or computer glazing; a screen component; glazing for a thermal, solar or photovoltaic panel; an article for the construction, furnishing, electrical appliance or decorative industry; an article for the games or toys industry; an article for the fashion industry, shoe heels or jewels; for the furniture industry, a table, seat or armchair component; a presentation, packaging, housing, box, container or flask article or component, an article for perfumery, cosmetics or pharmaceuticals; luggage; or a component for protection during transport, comprising a polyamide, the improvement wherein the polyamide is one according to claim 10.
